(19) United States
(12) Patent Application Publication
(10) Pub. No.: US 2026/0287321 A1
(43) Pub. Date: Sep. 24, 2026

(54) LINEAR ENCODER AND LINEAR CONVEYANCE SYSTEM

(71) Applicant: THK CO., LTD., Tokyo (JP)

(72) Inventor: Hiroyuki Yoshino, Tokyo (JP)

(73) Assignee: THK CO., LTD., Tokyo (JP)

(21) Appl. No.: 19/490,222

(22) PCT Filed: May 28, 2024
(86) PCT No.: PCT/JP2024/019598

§ 371 Date: Dec. 4, 2025

(30) Foreign Application Priority Data
Jun. 9, 2023 (JP) 2023-095687

(51) Int. Cl. G01B 7/00; G01D 5/12

(52) U.S. Cl. CPC G01B 7/003; G01D 5/12

(57) ABSTRACT

The present invention provides a linear encoder (60) including a sensor board (65), position detection sensors (64) provided on one surface (65A) of the sensor board (65), a positioning plate (62) provided with window portions (62b) in parts facing the position detection sensors (64), fixing portions (80) fixing the sensor board (65) to the positioning plate (62). The plurality of position detection sensors (64) are disposed inside the window portions (62b) in a state in which the one surface (65A) of the sensor board (65) abuts the positioning plate (62).

### TECHNICAL FIELD

The present invention relates to a linear encoder and a linear conveyance system. Priority is claimed on Japanese Patent Application No. 2023-095687, filed Jun. 9, 2023, the content of which is incorporated herein by reference.

### BACKGROUND ART

The following patent document 1 discloses an electronic scale using an inductive position transducer element. This electronic scale includes a first member; an elongated beam member having a measurement axis along which the first member is able to move; at least one magnetic field generator responding to a drive signal and generating a varying magnetic flux within a magnetic flux region; at least one magnetic flux modulator allowed to be disposed within the magnetic flux region and capable of changing the varying magnetic flux within a modulation region in the vicinity thereof; and at least one magnetic flux sensor disposed within the magnetic flux region, detecting a varying magnetic flux within the magnetic flux region, and generating an output signal indicating a relative position between a detected magnetic flux and the at least one magnetic flux modulator on the basis of the detected magnetic flux. Each of the magnetic field generators and each of the magnetic flux sensors form continuous and spatially modulated inductive coupling.

### CITATION LIST

### Patent Document

Patent Document 1: Japanese Unexamined Patent Application, First Publication No. H9-325002

### SUMMARY OF INVENTION

### Technical Problem

In the foregoing linear encoder, in order to perform measurement with high accuracy, it is necessary to accurately manage a gap dimension between a position detection sensor and a linear scale.

The present invention has been made in consideration of the foregoing circumstances, and an object thereof is to provide a linear encoder and a linear conveyance system capable of accurately managing a gap dimension between a position detection sensor and a linear scale.

### Solution to Problem

A first aspect of the present invention includes a sensor board, a plurality of position detection sensors provided on one surface of the sensor board, a positioning plate provided with a plurality of window portions in parts facing the plurality of position detection sensors, and fixing portions fixing the sensor board to the positioning plate. The plurality of position detection sensors are disposed within the plurality of window portions in a state in which the one surface of the sensor board abuts the positioning plate.

According to a second aspect of the present invention, in the linear encoder according to the first aspect, the fixing portions are provided on both sides of each of the plurality of position detection sensors.

According to a third aspect of the present invention, in the linear encoder according to the first aspect or the second aspect, each of the fixing portions includes a pillar member provided in the positioning plate, a collar member movable along the pillar member, and a fastening member fastening and fixing the collar member to the pillar member. Through holes which penetrate the sensor board from the one surface to the other surface and through which the pillar members are inserted are formed in the sensor board. The collar members abut the other surface of the sensor board in a state of being fastened and fixed to the pillar members.

According to a fourth aspect of the present invention, in the linear encoder according to the third aspect, the pillar members are fixed to the positioning plate by caulking.

According to a fifth aspect of the present invention, a linear conveyance system includes a mobile body including a linear scale; and a conveyance unit including a track body guiding the mobile body, and a linear encoder disposed along the track body and capable of facing the linear scale. A plurality of the conveyance units are joinable such that a plurality of the track bodies are connected in series. The linear encoder is the linear encoder according to the first aspect or the second aspect.

### Advantageous Effects of Invention

According to an aspect of the present invention, it is possible to accurately manage a gap dimension between a position detection sensor and a linear scale.

### BRIEF DESCRIPTION OF DRAWINGS

FIG. 1 An overall view of a linear conveyance system according to an embodiment.

FIG. 2 A perspective view of a mobile body and a conveyance unit according to the embodiment.

FIG. 3 A view of the mobile body and the conveyance unit according to the embodiment in an X axis direction.

FIG. 4 A view of the conveyance unit according to the embodiment in a Y axis direction.

FIG. 5 A rear perspective view of a linear encoder according to the embodiment.

FIG. 6 A rear perspective view of a mounting base and a positioning plate according to the embodiment.

FIG. 7 A cross-sectional view taken along arrow VII-VII shown in FIG. 4.

### DESCRIPTION OF EMBODIMENT

Hereinafter, an embodiment of the present invention will be described with reference to the drawings.

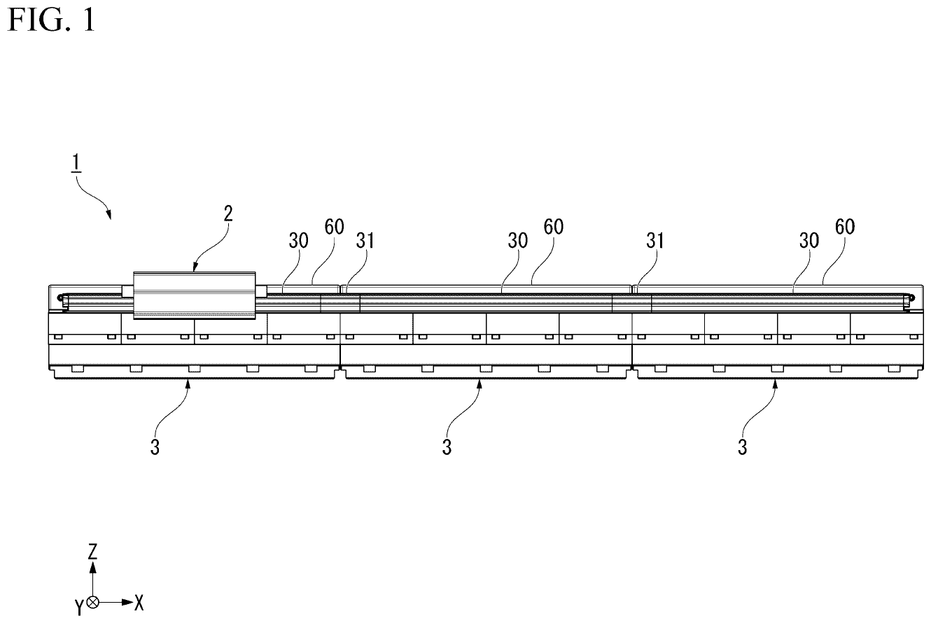

FIG. 1 is an overall view of a linear conveyance system 1 according to the embodiment.

As shown in FIG. 1, the linear conveyance system 1 includes a mobile body 2 and a conveyance unit 3. The conveyance unit 3 includes a track body 30 guiding the mobile body 2, and a linear encoder 60 disposed along the track body 30.

A plurality of conveyance units 3 are joinable such that a plurality of track bodies 30 are connected in series. In the example of FIG. 1, three conveyance units 3 are joined. A joint rail 31 is arranged between a track body 30 of the conveyance unit 3 and a track body 30 of an adjacent conveyance unit 3. The mobile body 2 can move along adjacent track bodies 30 joined as a single line by the joint rails 31.

In the following description, an XYZ orthogonal coordinate system is set, and the positional relationship of each member may be described with reference to this XYZ orthogonal coordinate system. An X axis direction is a length direction in which the track body 30 extends (moving direction of the mobile body 2). A Y axis direction is a width direction of the track body 30 orthogonal to the X axis direction. A Z axis direction is a height direction of the track body 30 orthogonal to the X axis direction and the Y axis direction.

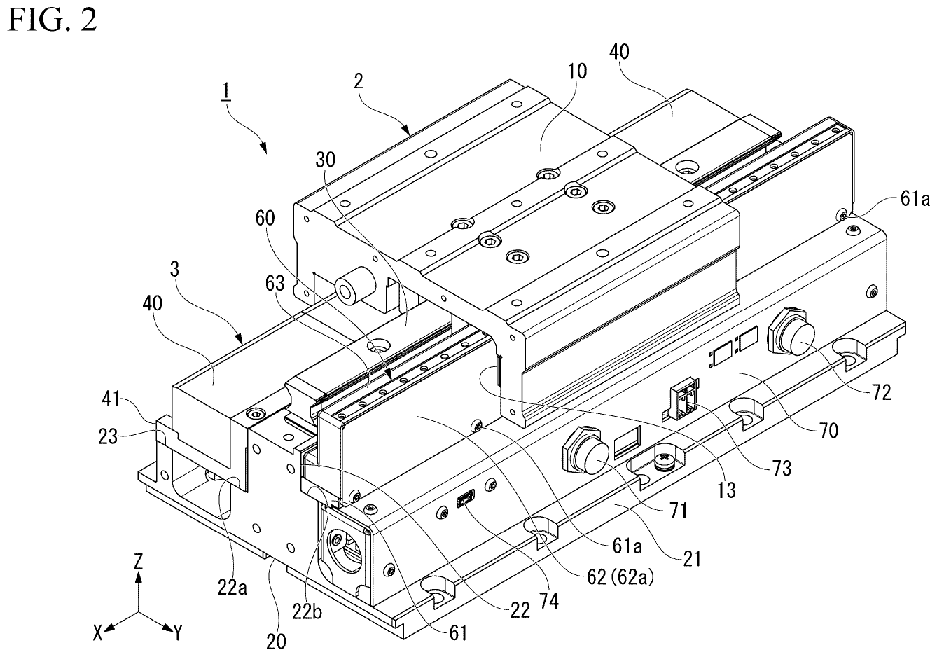

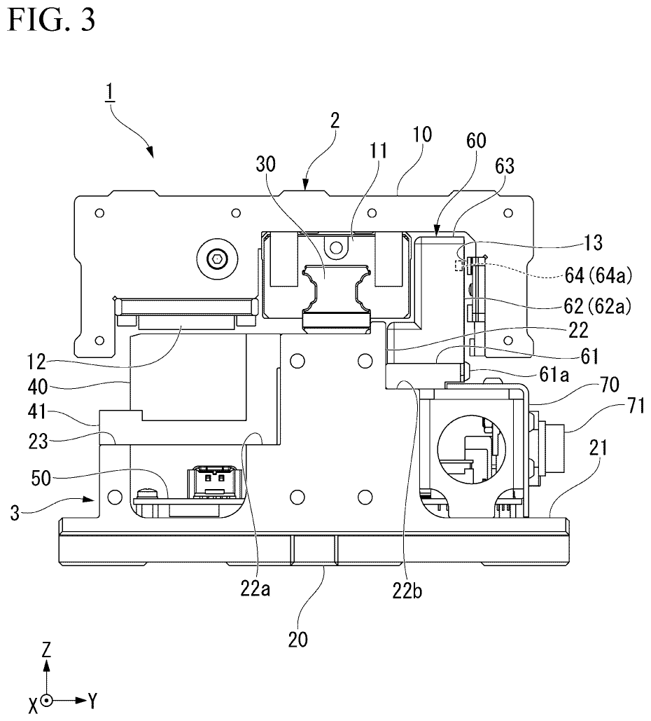

FIG. 2 is a perspective view of the mobile body 2 and the conveyance unit 3 according to the embodiment. FIG. 3 is a view of the mobile body 2 and the conveyance unit 3 according to the embodiment in the X axis direction.

As shown in FIG. 3, the mobile body 2 includes a table 10, a slider block 11, a magnet 12, and a linear scale 13.

The table 10 includes a top plate portion extending along an X-Y plane, and a pair of side wall portions hanging downward from both end portions of the top plate portion in the Y axis direction. A conveyance object (not shown) can be fixed on the upper surface side of the top plate portion of the table 10.

The slider block 11 is mounted on the lower surface side of the top plate portion of the table 10. The slider block 11 engages with the track body 30 in a manner of being movable in the X axis direction. Recessed portions are formed on side surfaces of the track body 30 on both sides in the Y axis direction, and the slider block 11 includes projection portions which engage with the recessed portions.

A rolling element transfer path for endlessly transferring a rolling element (not shown) may be formed between the recessed portions of the track body 30 and the projection portions of the slider block 11. For example, the rolling element transfer path may be provided in two rows in total, one row each on both sides of the track body 30 in the Y axis direction, or may be provided in four rows in total, two rows each on both sides of the track body 30 in the Y axis direction.

In addition, the magnet 12 is mounted on the lower surface side of the top plate portion of the table 10. The magnet 12 is disposed on the negative Y side of the slider block 11. The magnetic poles of the magnet 12 are directed downward. The downward magnetic poles of the magnet 12 are arranged such that the N poles and the S poles are alternately aligned in the X axis direction.

The linear scale 13 is mounted on an inner wall surface of the side wall portion of the table 10 on the positive Y side. The linear scale 13 is formed to have a thin plate-rod shape extending in the X axis direction. The linear scale 13 faces detection portions 64a of the linear encoder 60 in the Y axis direction. The linear scale 13 and the linear encoder 60 may be an optical type or a magnetic type.

The conveyance unit 3 includes a base member 20, the track body 30, coil units 40, a drive board 50, the linear encoder 60, and a cover 70. The base member 20 includes a bottom plate portion 21, a first column portion 22, and a second column portion 23. The bottom plate portion 21 is formed to have a plate shape extending along the X-Y plane.

The first column portion 22 stands upward (positive Z side) from a central portion of the bottom plate portion 21 in the Y axis direction. The track body 30 described above is mounted on the top portion of the first column portion 22. As shown in FIG. 2, the first column portion 22 extends in the X axis direction together with the track body 30. A first mounting portion 22a (step) is formed on a surface of the first column portion 22 directed to the negative Y side.

The second column portion 23 is disposed on the negative Y side of the first column portion 22 and stands upward (positive Z side) from the bottom plate portion 21. The second column portion 23 also extends in the X axis direction together with the first column portion 22 (first mounting portion 22a). The height of the top portion of the second column portion 23 is the same as the height of the first mounting portion 22a. A support member 41 is laid between the second column portion 23 and the first mounting portion 22a.

As shown in FIG. 3, the support member 41 is formed to have an L-shape when viewed in the X axis direction. The support member 41 supports the coil units 40.

The coil units 40 face the magnet 12 in the Z axis direction. The coil units 40 include a coil group of a U-phase, a V-phase, and a W-phase in the X axis direction. For example, a plurality of coil units 40 (four units in the present embodiment) are provided side by side in the X axis direction.

As shown in FIG. 3, the drive board 50 is disposed on a side (negative Z side) below the coil units 40 and is fixed to the bottom plate portion 21 thereabove. The drive board 50 is connected to the coil units 40 through cables (not shown) and controls movement of the mobile body 2 in the X axis direction by causing a current to flow to the coil units 40. The drive board 50 is disposed in a manner of penetrating the first column portion 22 in the Y axis direction.

The cover 70 covers a part protruding to the positive Y side beyond the first column portion 22 of the drive board 50. Various connectors connecting the drive board 50 and external devices (not shown) are provided in the cover 70. For example, the reference signs 71 and 72 shown in FIG. 2 indicate communication connectors. In addition, the reference sign 73 indicates a power connector. In addition, the reference sign 74 indicates a USB connector.

A second mounting portion 22b (step) is formed on a surface of the first column portion 22 directed to the positive Y side. The linear encoder 60 is mounted on the second mounting portion 22b. As shown in FIG. 3, the linear encoder 60 is formed to have an L-shape when viewed in the X axis direction. The linear encoder 60 includes a mounting base 61, a positioning plate 62, a sensor cover 63, and position detection sensors 64.

The mounting base 61 is formed to have a plate shape extending along the X-Y plane and is fixed to the second mounting portion 22b. The positioning plate 62 is mounted on an end portion of the mounting base 61 in the positive Y side using screw members 61a. The positioning plate 62 stands upward (positive Z side) from the end portion of the mounting base 61 in the positive Y side. The positioning plate 62 extends along an X-Z plane.

As shown in FIG. 2, the positioning plate 62 extends along the mobile body 2 in the moving direction (X axis direction) and faces the linear scale 13 in the Y axis direction. A protective film 62a is attached to a surface of the positioning plate 62 facing the linear scale 13. As shown in FIG. 3, a surface of the positioning plate 62 not facing the linear scale 13 is covered by the sensor cover 63. A sensor board 65 (which will be described below) is disposed on the inward side of the sensor cover 63.

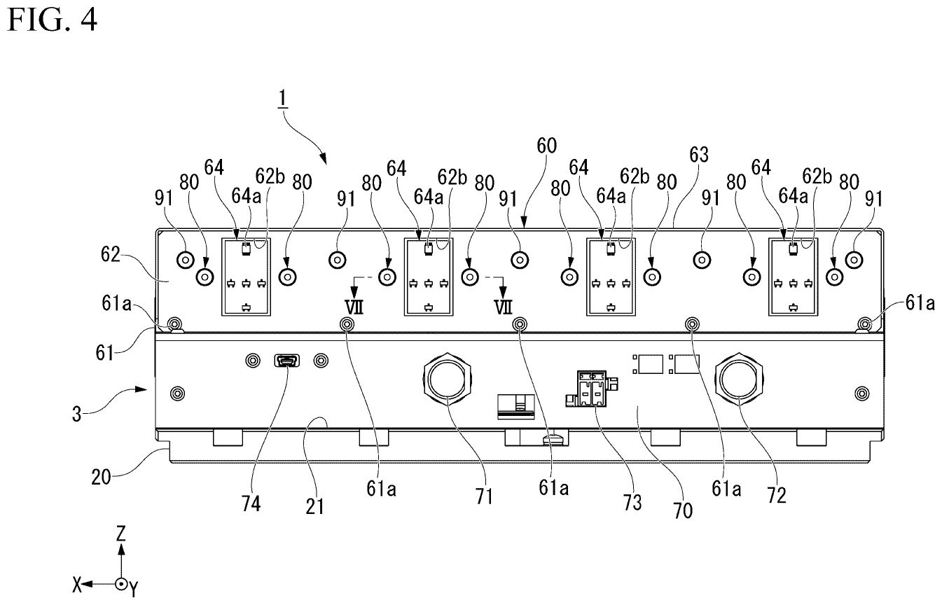

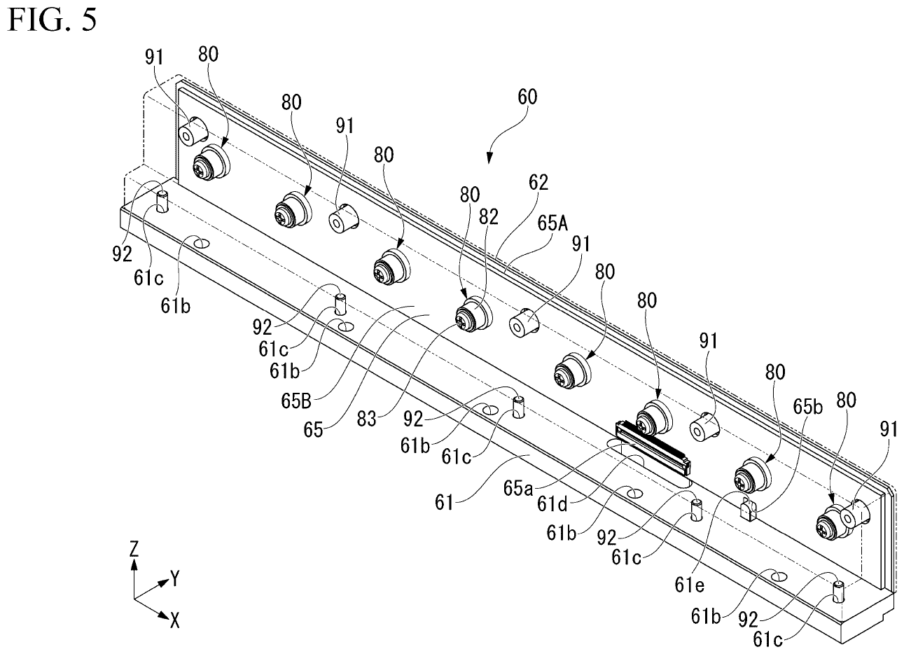

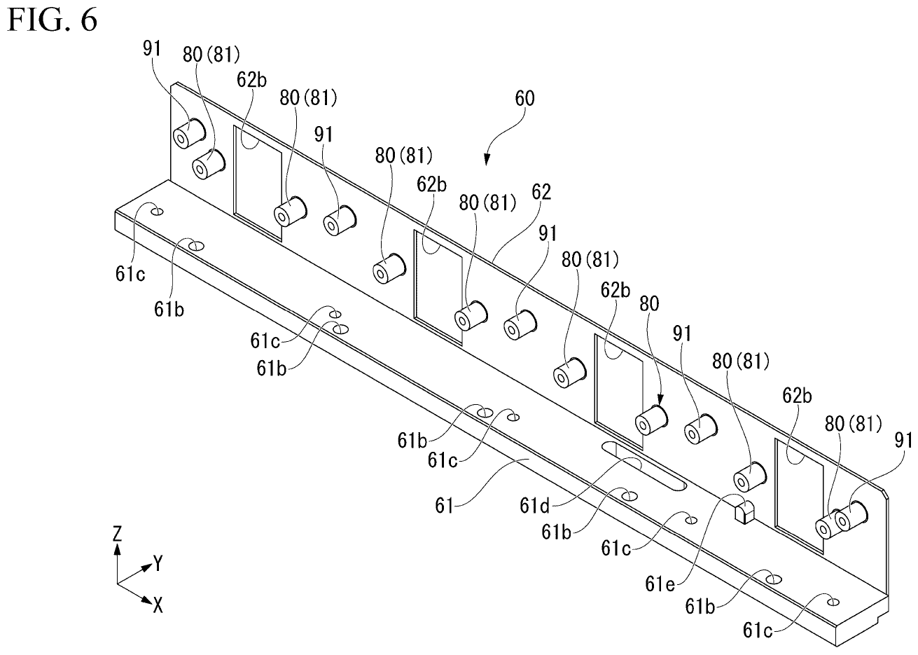

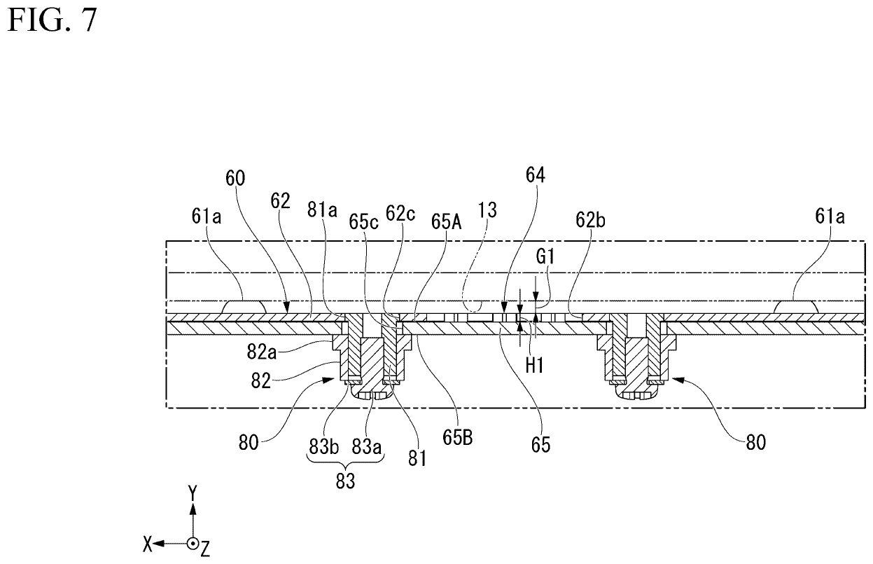

FIG. 4 is a view of the conveyance unit 3 according to the embodiment in the Y axis direction. FIG. 5 is a rear perspective view of the linear encoder 60 according to the embodiment. FIG. 6 is a rear perspective view of the mounting base 61 and the positioning plate 62 according to the embodiment. FIG. 7 is a cross-sectional view taken along arrow VII-VII shown in FIG. 4. In these views, for improved visibility, the protective film 62a of the positioning plate 62 is not shown.

As shown in FIGS. 5 and 7, the linear encoder 60 includes the sensor board 65. The position detection sensors 64 are provided on one surface 65A of the sensor board 65 directed to the positive Y side (linear scale 13 side). As shown in FIG. 4, a plurality of position detection sensors 64 (four in the present embodiment) are provided on the sensor board 65 with an interval therebetween in the X axis direction.

As shown in FIGS. 4 and 6, the positioning plate 62 includes a plurality of window portions 62b in parts facing the plurality of position detection sensors 64. In other words, a plurality of window portions 62b (four in the present embodiment) are provided in the positioning plate 62 with an interval therebetween in the X axis direction. The window portions 62b of the present embodiment are rectangular openings formed in the positioning plate 62, but the shape is not limited to a rectangular shape as long as it is a shape corresponding to the position detection sensors 64.

The sensor board 65 is fixed to the positioning plate 62 using fixing portions 80, which will be described below. As shown in FIG. 4, the fixing portions 80 are provided on both sides of each of the plurality of position detection sensors 64 in the X axis direction. As shown in FIG. 7, elements of the position detection sensors 64 (including the detection portions 64a) are disposed within the window portions 62b in a state in which the one surface 65A of the sensor board 65 abuts the positioning plate 62.

As shown in FIG. 5, first fixing holes 61b, second fixing holes 61c, and an elongated hole 61d are formed in the mounting base 61. Screw members (not shown) for mounting the mounting base 61 on the second mounting portion 22b (refer to FIGS. 2 and 3) are disposed in the first fixing holes 61b. A plurality of first fixing holes 61b are formed with an interval therebetween in the X axis direction along an edge of the mounting base 61 on the negative Y side.

The second fixing holes 61c are formed on the positive Y side of the mounting base 61 from the first fixing holes 61b. Screw members 92 for fixing the sensor cover 63 from below in the Z axis direction are disposed in the second fixing holes 61c. The sensor cover 63 is also fixed in the Y axis direction to a plurality of fixing cylinders 91, which is fixed to the positioning plate 62, using screw members (not shown).

As shown in FIG. 5, the elongated hole 61d is formed along the edge of the mounting base 61 on the positive Y side. A connection wiring (not shown), which can be connected to a connector 65a provided on the other surface 65B of the sensor board 65, is disposed in the elongated hole 61d. The connection wiring electrically connects the sensor board 65 and the drive board 50 to each other. The other surface 65B of the sensor board 65 is a surface directed to the negative Y side, and it is a surface directed opposite to the one surface 65A directed to the positive Y side (linear scale 13 side).

A positioning projection 61e for positioning the sensor board 65 in the X axis direction is formed on the positive X side of the elongated hole 61d of the mounting base 61. The positioning projection 61e stands upward (positive Z side) from the edge of the mounting base 61 on the positive Y side. A positioning recess portion 65b which engages with the positioning projection 61e is formed at a lower edge of the sensor board 65. The positioning recess portion 65b is recessed upward (positive Z side).

As shown in FIG. 7, each of the fixing portions 80 includes a pillar member 81 provided on the positioning plate 62, a collar member 82 movable in the Y axis direction along the pillar member 81, a fastening member 83 for fastening and fixing the collar member 82 to the pillar member 81. The pillar member 81 is located at a position different from that of the fixing cylinders 91 described above (refer to FIG. 6) but has the same configuration.

The pillar member 81 is formed to have a cylindrical shape extending from the positioning plate 62 to the negative Y side. A female thread is formed on an inner circumferential surface of the pillar member 81. The pillar member 81 is made of a metal and is fixed to the positioning plate 62 by caulking, as shown in FIG. 7. A deformed portion 81a having a larger diameter than an outer circumferential surface of the pillar member 81 is formed in an end portion of the pillar member 81 on the positive Y side.

The deformed portion 81a includes an expanded portion larger than a fixing hole 62c formed in the positioning plate 62 before being caulked with respect to the positioning plate 62. This deformed portion 81a is positionally set in the fixing hole 62c, and the expanded portion is pushed into the fixing hole 62c using a press machine or the like. Accordingly, the expanded portion is deformed so that the pillar member 81 can be fixed to the positioning plate 62.

The collar member 82 is made of a resin and is formed to have a cylindrical shape which is slidable in the Y axis direction along the outer circumferential surface of the pillar member 81. An annular flange portion 82a having a larger diameter than an outer circumferential surface of the collar member 82 is formed in an end portion of the collar member 82 on the positive Y side. The flange portion 82a abuts the other surface 65B of the sensor board 65 and fixes (clamps) the sensor board 65 between flange portion 82a and the positioning plate 62.

The fastening member 83 includes a screw member 83a and a washer member 83b. The screw member 83a is screwed into the pillar member 81 from the negative Y side. The washer member 83b is interposed between an opening edge of the collar member 82 on the negative Y side and a head portion of the screw member 83a. When the outer diameter of the head portion of the screw member 83a is larger than the inner diameter of the collar member 82, the washer member 83b does not necessarily have to be provided.

Through holes 65c which penetrate the sensor board 65 from the one surface 65A to the other surface 65B and through which the pillar members 81 are inserted are formed in the sensor board 65. The outer diameter of the flange portion 82a of the collar member 82 is larger than the inner diameter of the through hole 65c. If the fastening member 83 (screw member 83a) is tightened, the collar member 82 abuts the other surface 65B of the sensor board 65 so that the one surface 65A of the sensor board 65 is fixed in a state of abutting the positioning plate 62.

According to this constitution, as shown in FIG. 7, the only factor causing an error in the dimension of a gap G1 between the position detection sensors 64 and the linear scale 13 is heights H1 of elements of the position detection sensors 64. That is, the thickness and the like of the sensor board 65 do not become an error factor in the dimension of the gap G1. Accordingly, it is possible to accurately manage the dimension of the gap G1 between the position detection sensors 64 and the linear scale 13.

As described above, the linear encoder 60 of the present embodiment includes the sensor board 65, the plurality of position detection sensors 64 provided on the one surface 65A of the sensor board 65, the positioning plate 62 provided with the plurality of window portions 62b in parts facing the plurality of position detection sensors 64, and the fixing portions 80 fixing the sensor board 65 to the positioning plate 62. The plurality of position detection sensors 64 are disposed within the plurality of window portions 62b in a state in which the one surface 65A of the sensor board 65 abuts the positioning plate 62. According to this constitution, it is possible to accurately manage the dimension of the gap G1 between the position detection sensors 64 and the linear scale 13.

In addition, in the present embodiment, the fixing portions 80 are provided on both sides of each of the plurality of position detection sensors 64. According to this constitution, the one surface 65A of the sensor board 65 is in a state of abutting the positioning plate 62 on at least both sides of the position detection sensors 64.

Accordingly, it is possible to more accurately manage the dimension of the gap G1 between the position detection sensors 64 and the linear scale 13.

In addition, in the present embodiment, each of the fixing portions 80 includes the pillar member 81 provided in the positioning plate 62, the collar member 82 movable along the pillar member 81, and the fastening member 83 fastening and fixing the collar member 82 to the pillar member 81. The through holes 65c which penetrate the sensor board 65 from the one surface 65A to the other surface 65B and through which the pillar members 81 are inserted are formed in the sensor board 65. The collar members 82 abut the other surface 65B of the sensor board 65 in a state of being fastened and fixed to the pillar members 81. According to this constitution, the one surface 65A of the sensor board 65 can be brought into close contact with the positioning plate 62 without causing the fixing portions 80 to protrude to the linear scale 13 side (positive Y side). Accordingly, the gap G1 can be reduced.

In addition, in the present embodiment, the pillar members 81 are fixed to the positioning plate 62 by caulking. According to this constitution, compared to when the pillar members 81 are welded or the like to the positioning plate 62, distortion is less likely to occur in the positioning plate 62. Accordingly, it is possible to more accurately manage the dimension of the gap G1 between the position detection sensors 64 and the linear scale 13. Although more processing costs are required than caulking, the positioning plate 62 and the pillar members 81 may be formed by cutting, for example.

In addition, the linear conveyance system 1 of the present embodiment includes the mobile body 2 including the linear scale 13; and the conveyance unit 3 including the track body 30 guiding the mobile body 2, and the linear encoder 60 disposed along the track body 30 and capable of facing the linear scale 13. The plurality of conveyance units 3 are joinable such that the plurality of track bodies 30 are connected in series. According to this constitution, it is possible to accurately manage the dimension of the gap G1 between the position detection sensors 64 and the linear scale 13 in each conveyance unit 3. Accordingly, even if a plurality of conveyance units 3 are joined, the accuracy in detecting the position of the mobile body 2 in the linear conveyance system 1 in its entirety can be enhanced.

Hereinabove, a preferred embodiment of the present invention has been described with reference to the drawings, but the present invention is not limited to the embodiment described above. The shapes, the combinations, and the like of the constituent members shown in the embodiment described above are merely examples, and various modifications can be made based on design requirements and the like within a range not departing from the spirit of the present invention.

### INDUSTRIAL APPLICABILITY

According to an aspect of the present invention, it is possible to accurately manage a gap dimension between a position detection sensor and a linear scale.

### REFERENCE SIGNS LIST

1 Linear conveyance system
2 Mobile body
3 Conveyance unit
13 Linear scale
30 Track body
60 Linear encoder
62 Positioning plate
62b Window portion
64 Position detection sensor
64a Detection portion
65 Sensor board
65A One surface
65B The other surface
80 Fixing portion
81 Pillar member
82 Collar member
83 Fastening member
H1 Element height
G1 Gap

1. A linear encoder comprising:
a sensor board;
a plurality of position detection sensors provided on one surface of the sensor board;
a positioning plate provided with a plurality of window portions in parts facing the plurality of position detection sensors; and
fixing portions fixing the sensor board to the positioning plate,
wherein the plurality of position detection sensors are disposed within the plurality of window portions in a state in which the one surface of the sensor board abuts the positioning plate.

2. The linear encoder according to claim 1,
wherein the fixing portions are provided on both sides of each of the plurality of position detection sensors.

3. The linear encoder according to claim 1,
wherein each of the fixing portions includes
a pillar member provided in the positioning plate,
a collar member movable along the pillar member, and
a fastening member fastening and fixing the collar member to the pillar member,
through holes which penetrate the sensor board from the one surface to the other surface and through which the pillar members are inserted are formed in the sensor board, and
the collar members abut the other surface of the sensor board in a state of being fastened and fixed to the pillar members.

4. The linear encoder according to claim 3,
wherein the pillar members are fixed to the positioning plate by caulking.

5. A linear conveyance system comprising:
a mobile body including a linear scale; and
a conveyance unit including a track body guiding the mobile body, and a linear encoder disposed along the track body and capable of facing the linear scale,
wherein a plurality of the conveyance units are joinable such that a plurality of the track bodies are connected in series, and
the linear encoder is the linear encoder according to claim 1.
